(19) United States
(12) Patent Application Publication
(10) Pub. No.: US 2014/0155137 A1
(43) Pub. Date: Jun. 5, 2014

(54) SLOT MACHINE GAMING SYSTEM FOR POINT OF SALE TERMINALS

(71) Applicants: Florian Schrotter, Traiskirchen (AT); Harald Kaiblinger, Pfaffstatten (AT)

(72) Inventors: Florian Schrotter, Traiskirchen (AT); Harald Kaiblinger, Pfaffstatten (AT)

(73) Assignee: NOVOMATIC AG, Gumpoldskirchen (AT)

(21) Appl. No.: 13/918,433

(22) Filed: Jun. 14, 2013

Related U.S. Application Data
(63) Continuation of application No. 12/945,852, filed on Nov. 13, 2010, now abandoned.

(51) Int. Cl. G06Q 50/34; G07F 17/34; G06Q 20/20

(52) U.S. Cl. CPC G06Q 50/34; G06Q 20/209; G07F 17/34
USPC 463/20

(57) ABSTRACT

A point of sale system uses change from cash transactions to, upon the approval of a customer, purchase a lottery stake. The system generates a receipt for both the point of sale transaction and the lottery stake purchase. The receipt indicates when the customer has won. In particular the receipt has imprinted a list of items purchased and a lottery indicator imprinted on the receipt for indicating whether the receipt is a winner. Ideally, the receipt is printed on paper and includes a subtotal, a tax line item, a total, and a change line item. At least a portion of the change line amount represents the lottery stake. In one embodiment of the invention, the receipt includes the statement: “You Won!”.

### FIELD OF THE INVENTION

The present invention relates lotteries, and particularly to entry into a lottery at a point-of sale transaction.

### BACKGROUND OF THE INVENTION

Points of sale transactions are numerous throughout the world. Millions of people per day buy goods at stores and pay for the goods with cash, credit cards, debit cards or with other means. When people use cash, change is given most of the time. The amount of change given worldwide, on any given day, is enormous.

A lottery is an event whose outcome is determined by chance. Lotteries are popular. In some lotteries, tickets are issued in advance and there is a weekly or monthly drawing to determine winners. Typically lotteries require a fixed price to buy a stake in the lottery and are not instantly decided.

Casino game play relies often on the concept of a lottery, particularly with slot machine play and other game play. A winner is determined by chance. Casino gaming machines typically require a fixed price to play the game.

The odds of winning a slot machine game are sometimes dependent on the fee paid by the gamer. In some slot machine games, the likelihood of winning increases with the amount paid to play the game. For example, when one coin, token, or credit is used, the odds of winning are limited, and when a few coins, tokens or credits are used the odds increase.

In recent years, the seemingly distinct boundary between point of sale terminals and gaming machines has dissipated. This is evidenced by recent technical publications,

US Patent Application Publication No. US20100120520 to Roemer et al., for example, discloses a point-of-sale gaming system. The system comprises a point of sale device and a gaming machine that is associated with a point of sale device.

A party engages in a purchase transaction, such as the purchase of goods or services from a merchant. The transaction is processed via the point of sale device. Upon rendering payment, if the party is entitled to monetary change, the amount of the change is transferred to the gaming machine. That transferred change is accepted as a wager at the gaming machine, which presents a wagering game offering a chance for winnings. Winnings are paid via the point of sale device, such as in the form of money from a cash register, or in the form of a redeemable winnings receipt.

However, the Roemer gaming system has some drawbacks. Particularly, the concept of throughput time for point of sale transactions is not adequately addressed. This can result in time delays and inconvenience for a user of such a system and/or additional users that are waiting in a check-out line.

There is a need to provide point of sale gaming, which entertains customers, and which does not significantly increase the average point of sale transaction time.

### SUMMARY OF THE INVENTION

A point of sale system includes access to an instant lottery. The system has various components including a cash register having a printer for printing a receipt for a point of sale transaction, a computer adapted to communicate with the cash register to enable the cash register to calculate tax, subtotals and change for cash transactions. The change calculated by the computer has a value representing a lottery stake and the computer being further adapted to communicate with a remote gaming server to request a win-result and to determine whether the point of sale transaction is a winner and the printer prints a receipt indicating whether the receipt is a winner.

In one embodiment of the invention, the computer communicates to a remote server that operates the lottery. The term “lottery” in accordance with the present invention, includes any event whose outcome is determined by chance, and which has the possibility of yielding a payout. Accordingly, games including slot machines, roulette, poker games, and others can be considered to fall under the scope of the term “lottery”. Such games have an interface that can quickly be presented to a customer at any point of sale interface, enabling play lasting less than 10-15 seconds, and preferably less than 5 seconds. In one embodiment, play is simply the step of approving the use of change for a lottery stake, which happens in an instant.

One way to reduce play time in any point of sale location (to reduce store lines) is to keep the stakes low. Here the change given at the point of sale location is wagered. Presumably, a customer will not spend an undue amount of time deciding whether to play or not.

In another embodiment, the amount wagered is limited to less than a dollar, i.e. the cent value of any change given. The customer is given change in the form of paper money, however, the coins are wagered. In this way, no change is counted and given to a customer. This method yields a net decrease in average point of sale transaction time because no change is given. The fact that the customer is engaged in lottery play actually decreases the point of sale transaction time.

Another way to reduce play time in any point of sale location is to make the lottery simple. With the actuation of one approval button on a point of sale interface, the computer submits a request to a central server to determine whether the customer is a winner. The customer is notified on a receipt. The receipt has two purposes, one is to tally the items purchased, and the other is to indicate whether the customer is a winner or not.

A method in accordance with the present invention includes providing a point of sale terminal including a cash register, an electronic item scanner and a printer. The point of sale terminal being in communication with a remote game server for operating a lottery game.

The method includes scanning an item with the item scanner to enable the point of sale terminal to determine a subtotal, adding tax to the subtotal to generate a total, receiving payment via the cash register of at least the total, and calculating a change amount by subtracting the total from the payment received.

The method further includes using a portion of the change amount as a lottery stake, and once the lottery stake is established, requesting a win result from the remote gaming server. Once the win result is communicated from the remote gaming server to the point of sale terminal, the terminal prints a receipt with the printer including a list of items purchased and a lottery indicator imprinted on the receipt for indicating whether the receipt is a winner.

The step of printing the receipt includes printing the name of at least one item and its price, printing a subtotal, tax, total, and change. In one embodiment of the invention the words: “you won!” are printed on the receipt.

The step of using the change due includes displaying a menu to a user to enable the user to pre-approve the use of the portion of the change amount as a lottery stake. In one embodiment the portion of the change amount used as a lottery stake is 100% of the change amount.

In an alternate embodiment of the invention, the change given exceeds one dollar, in order to speed the point of sale transaction and to minimize customer decision-making time, the step of using the change amount uses only the cent value of the change amount and the whole dollar values of the change amount are returned to the customer. The cent value is a decimal having a value of between 0.01 to 0.99 and, thus, the cent value always being less than one dollar.

Accordingly the present invention may reduce average throughput times of customers at point of sale terminals by minimizing the number of transactions where coin change is given to a customer. The present invention also entertains customers at point of sale terminals, such as seen at grocery store check-out locations. The present invention also interests point of sale customers by offering the possibility of winning a lottery prize.

### BRIEF DESCRIPTION OF THE DRAWINGS

FIG. 1 shows a point of sale system including a cash register and a computer.

FIG. 2 shows a system diagram in accordance with the present invention.

FIG. 3 shows a flowchart in accordance with the present invention.

FIG. 4 shows a winning point of sale receipt in accordance with the present invention.

FIG. 5 shows a losing point of sale receipt in accordance with the present invention.

### DETAILED DESCRIPTION

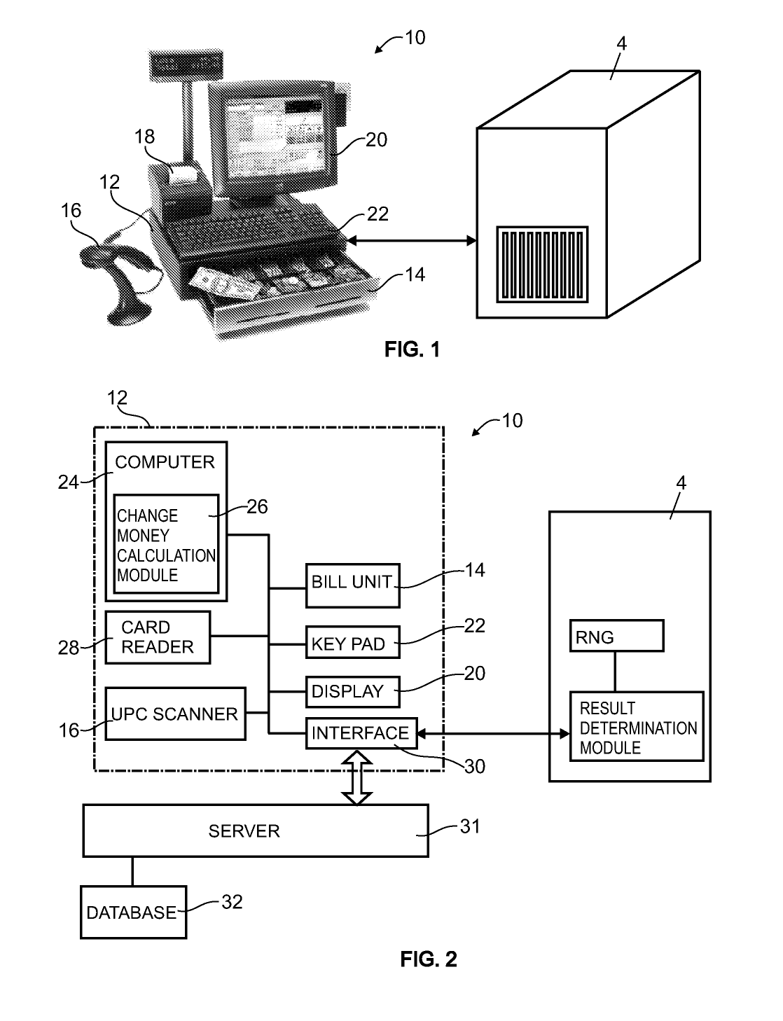

FIG. 1 shows a point of sale terminal 10 including a cash register 12 connected to a remote game server 4 via a network connection. The cash register 12 includes a cash drawer 14, a UPC code scanner 16, a printer 18 for printing receipts, and at least one display 20. The cash register 12 also includes a keypad 22.

The cash register 12 includes an internal computer coupled with the display 20, the printer 18, the UPC code scanner 16 and the keypad 22. The computer is capable of performing routine calculations and interface operations.

It can be appreciated that while the UPC code scanner 16 is shown, it could readily be replaced or supplemented with a smart card/chip reader to input product information and other data commonly used at point of sale terminals.

FIG. 2 shows a system diagram of the point of sale terminal 10 of the present invention including the cash register 12. The cash register 12 includes the computer 24, which comprises a change money calculation module 26. The cash register 12 may further comprise a card reader 28. The cash drawer 14 has a bill unit for holding paper bills. The key pad 22 and the display 20 operatively connect with the computer 24 of the cash register 12. The card reader 28 enables credit and debit card transactions.

The cash register 12 also communicates to a merchant server 31 via an electronic network. The merchant server 31 includes a database 32.

The gaming server 4 includes a controller having a program memory, a microcontroller or microprocessor (MP), a random-access memory (RAM) and an input/output (I/O) circuit, all of which may be interconnected via an address/data bus.

The program memory of the controller may be read-only memory (ROM), a read/write or alterable memory, such as a hard disk. In the event a hard disk is used as a program memory, the address/data bus may comprise multiple address/data buses, which may be of different types, and there may be an I/O circuit disposed between the address/data buses.

A computer program residing on the game server 4 includes portions to operate the game server 4 be written in any high level language such as C, C++, C#, Java or the like or any low-level assembly or machine language. By storing the computer program portions therein, various portions of the memories are physically and/or structurally configured in accordance with computer program instructions.

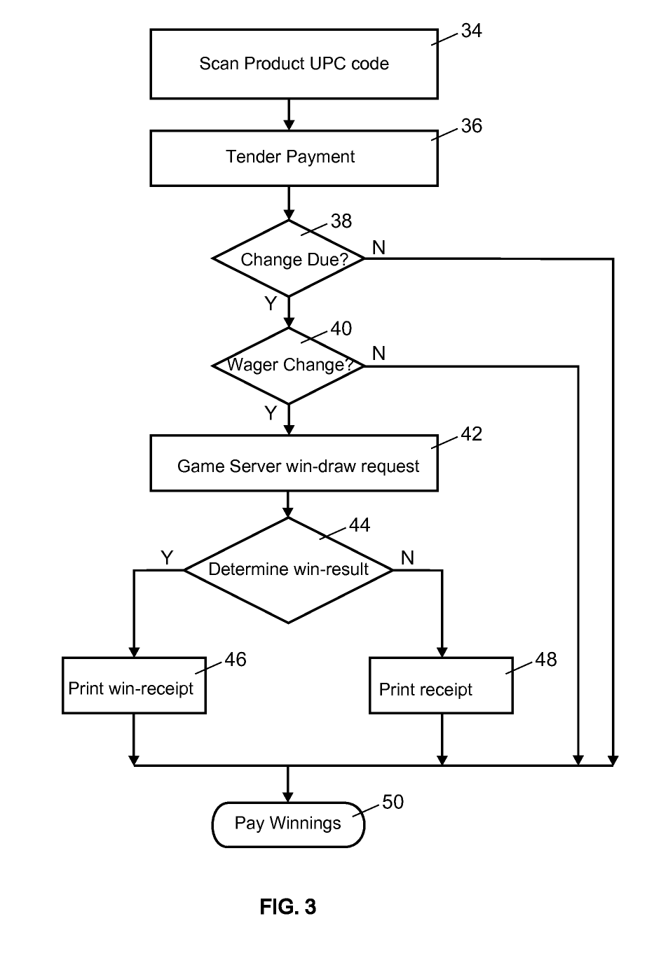

FIG. 3 shows a flow chart of a method in accordance with the invention that enables lottery play, where each lottery lot can be purchased for a variable fee. Preferably the fee is the amount of change given at a point of sale terminal. The odds of winning and the amount of payout can depend on the fee paid for the lottery lot.

According to step 34, when a purchaser brings items for purchase to the checkout counter of a point of sale location, for instance a grocery store, the Universal Product Code (UPC) on a label on the item, or on a package in which the item is sold, is optically scanned using the UPC code scanner. The scanned UPC code is electronically communicated to the computer. Optionally, price labels or UPC codes are read by a cashier who manually enters the prices or codes into the computer using the keypad on the cash register. The information pertaining to each item is generally available to the computer by cross-referencing the UPC bar code with UPC information, such as the price and description of each item, stored in database. Cross-referencing the UPC code enables the computer to determine the price and description of each item and to automatically update inventory records. The computer publishes the price and description on the display of the cash register. The prices of multiple items are totaled and applicable taxes are determined using the computer, and the total amount of payment due from the purchaser is provided on the display. The display may be any of a variety of visual displays including a video monitor, liquid crystal display (LCD) or light emitting diode (LED).

The change money calculation module is in the control of the following procedure:

Upon tender of payment, step 36, it is determined according to step 38 whether the customer is entitled to any monetary change, that is to say a sum of money comprising the difference between the amount tendered by the party as payment and the amount owing; i.e. an overpayment. If there is entitlement of monetary change, Y, then the customer may be provided the opportunity, step 40, to wager the change, or a portion thereof

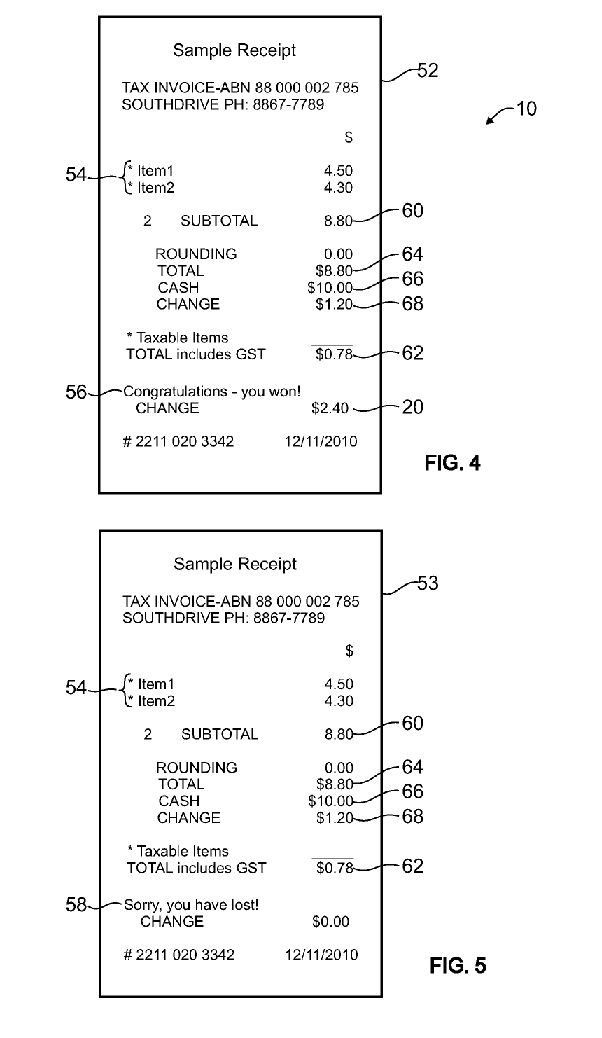

In case there is a decision, Y, to wager the change then the cash register requests, step 42, a win-draw from the remote gaming server 4. Thereafter a win result is determined, step 44. In case of a win, Y, at step 44 the win amount will be paid and the customer receipt is printed, step 46, as shown in FIG. 4. In case there is no win, N, at step 48 then the no win amount will be paid and the customer receipt is printed. Step 50 pays the winnings, if any, or change due.

The point of sales terminal can accept payment in various forms. For example, the point of sales might accept a credit or debit card, money in the form of currency or coins, or other manners of payment. For example, if a party pays by a credit card or tendered the exact amount of money owing for the transaction, then no change may be due to the party from the point of sale.

For example, the operator of the point of sale device might pay the player their winnings in paper currency or coins. Alternatively, however, the player might be awarded their winnings in the form of a ticket or other media which bears the game result or amount won. Such a ticket might be redeemed for money, or be utilized in other transactions, such as being accepted at another gaming machine, a vending device or the like.

Alternatively various prizes might be awarded instead of paper currency or coins. Such various prizes might comprise goods, services, discounts or other non-monetary awards. Such non-monetary awards might be awarded for particular outcomes of the game. In addition, the point of sale might offer to the customer to re-start the opportunity to wager the new change.

The cash register of the present invention may be integrated with other methods of tracking purchasers. Some businesses may issue discount or membership accounts to their customers, usually facilitated with cards or key ring tags bearing a bar code, or electronically detectable transponder and issued to the purchaser for use at the time of transactions with that business. The cards or key ring tags may be scanned and read using an OCR scanner, and the information provided identifies the customer who is the discount or membership account holder. Identification is generally made through the same method used for identifying an item using a UPC code; that is, an identifying bar code is read and the computer cross-references the identifying bar code with the corresponding account holder. The identifying codes and account holders are cross-referenced using records stored in database 32 or another database. Identifying the account holder who is purchasing items enables the business to automatically track purchases made by that customer using the identifying bar code (or electronically detectable transponder) so long as the bar code is scanned at the time of the transaction. Transaction information including the date, time, location and purchaser, may be electronically associated with the denomination and serial numbers of bills received from that purchaser, and that information may be recorded in database 32 (FIG. 2). Optionally, the business may issue electronically detectable transponders to its customers/account holders which, when scanned and detected at the time of the transaction, provide information to the computer 5 which can be associated with bills received or dispensed to the purchaser in connection with the transaction.

Optionally, included among the account holder identification information recorded in the database is an electronic address for the purchaser. The purchaser's electronic address is provided by the purchaser upon applying for the discount or membership account. The availability of the purchaser's electronic address enables the business operating the cash register to provide account information to the purchaser by electronic communications using the Internet. Information that can be provided to the purchaser may include any or all of the transaction information recorded in the database, including the amount of money spent by the purchaser at the business within any given time period or upon any specific transaction, the specific items purchased by the purchaser at each transaction, and the denominations and serial numbers of bills dispensed to the purchaser by the cash register in making change at each transaction. This information can be downloaded from the Internet into a personal computer used by the purchaser, and it can be used by the purchaser to manage cash transactions and in surveillance of purchases and cash transactions by family members or dependents. This information can also be stored in a personal financial manager.

FIG. 4 and FIG. 5 show a receipt 52 and 53, respectively, in accordance with the present invention. Each receipt 52, 53 includes a list of items purchased 54. Receipt 52 includes a lottery indicator 56 imprinted on the receipt 52. Receipt 53 includes a lottery indicator 58 imprinted on the receipt 53.

Each receipt 52, 53 also includes an imprinted subtotal 60, a tax line item 62, a total 64, an amount paid 66 and change 68.

In FIG. 4, the receipt 52 is a winning receipt and the lottery indicator 56 includes the text “Congratulations—you won!”. Following the text, the lottery indicator includes an amount won 70. The amount won is typically paid in cash by the point of sale system.

In FIG. 5 the lottery indicator 58 includes the text, “Sorry, you have lost!”. The amount paid to the customer under this scenario is zero.

While the present invention is described herein in terms of various embodiments, it can be appreciated that numerous embodiments are possible. Accordingly the present invention should be limited only by the appended claims.

1-18. (canceled)

19. A point of sale system for point of sale transactions and for enabling play of a slot-machine game, comprising:
a game server including a processor, a database for storing customer electronic addresses, the game server being programmed with software for operating a slot-machine game and for displaying the slot-machine game to a customer;
a cash register in communication with the game server, the cash register includes a computer adapted to communicate with the game server to enable the slot-machine game;
a display connected with the cash register to display the slot-machine game;
a printer connected with the cash register for printing a receipt for point of sale transactions and for a slot-machine game result;
the cash register being adapted to communicate with the game server to enable a customer to play the slot-machine game and to request a slot machine game result, and
the printer prints a receipt indicating the slot machine game result.

20. A point of sale system as set forth in claim 19, wherein the game server database includes customer electronic addresses, and electronically communicates at least a portion of the point of sale transaction to the customer electronic address.

21. A point of sale system as set forth in claim 19, wherein when the receipt indicates that the receipt is a winner and the receipt is redeemable for cash.

22. A point of sale system as set forth in claim 19, wherein the receipt includes printing the name of at least one item and its price.

23. A point of sale system as set forth in claim 19, wherein the cash register includes a UPC scanner for scanning an item, the printer prints a receipt describing the item.

24. A point of sale system set forth in claim 19, wherein the printer prints a receipt including the text: “you won!” on the receipt.

25. A point of sale system for conducting point of sale transactions and for enabling play of a slot-machine game, comprising:
a game server including a processor, a database for storing customer electronic addresses, the game server being programmed with software for operating a slot-machine game and for displaying the slot-machine game to a customer;
a cash register in communication with the game server;
a UPC scanner included with the cash register for scanning an item;
the cash register includes a computer adapted to communicate with the game server to enable the slot-machine game;
a display connected with the cash register to display the slot-machine game;
a printer connected with the cash register for printing a receipt for point of sale transactions and for slot-machine game results;
the printer prints a receipt indicating point of sale transaction including a description of any item scanned by the UPC scanner and any slot machine game result; and
the game server database includes customer electronic addresses and electronically communicates at least a portion of the point of sale transaction including the slot machine game result to the customer electronic address.

26. A point of sale system as set forth in claim 25, wherein the point of sale transaction is a cash transaction and at least a portion of change amount due is used as a stake.

27. A point of sale system as set forth in claim 26, wherein the display requests user pre-approval before wagering the stake.

28. A point of sale system as set forth in claim 27, the portion of the change amount used as a stake is 100% of the change amount.

29. A point of sale system as set forth in claim 27, the change amount uses the cent value of the change amount, the cent value being less than one dollar.

30. A point of sale system as set forth in claim 25, wherein the point of sale transaction is selected from the group consisting of: a credit card transaction, and a debit card transaction.

31. A point of sale system for cash transactions and for slot-machine game play, comprising:
a game server including a processor, the game server being programmed with software for operating a slot-machine game and for displaying the slot-machine game to a customer;
a cash register in communication with the game server, the cash register includes a UPC scanner for scanning items;
a computer adapted to communicate with the game server and the cash register to calculate a change value resulting from a cash transaction as a stake for the slot-machine game;
a display connected with the cash register to display the slot-machine game;
a printer connected with the cash register for printing a receipt for cash transactions and for slot-machine game results;
the cash register being adapted to communicate with the game server to enable a customer to play the slot-machine game, using the change value as a wager, and to request a win-result;
the game server communicates the win result to the cash register; and
the printer prints a receipt including a description of any item scanned by the UPC scanner and any slot machine game result.

32. A point of sale system for point of sale transactions as set forth in claim 31, wherein the game server includes a database for storing customer electronic addresses.

33. A point of sale system for point of sale transactions as set forth in claim 32, wherein the game server database stores customer electronic addresses and electronically communicates cash transaction data the slot machine game result to the customer electronic address.

34. A point of sale system for point of sale transactions as set forth in claim 33, wherein the cash register is adapted with a card reader to enable credit and debit card transactions.

35. A point of sale system for point of sale transactions as set forth in claim 34, where the computer enables the customer to choose a stake amount.

36. A point of sale system for point of sale transactions as set forth in claim 34, wherein the receipt includes text detailing a subtotal, tax and a total that reflect scanned items.

37. A point of sale system for point of sale transactions as set forth in claim 35, wherein the game result includes winnings from the slot machine game.

38. A point of sale system for point of sale transactions as set forth in claim 36, wherein the receipt includes the test, “you won!”.
